(19) United States
(12) Patent Application Publication
(10) Pub. No.: US 2009/0136134 A1
(43) Pub. Date: May 28, 2009

(54) IMAGE PROCESSING APPARATUS, IMAGE PROCESSING METHOD, COMPUTER-READABLE MEDIUM AND COMPUTER DATA SIGNAL

(75) Inventor: Yasuhiko IWAMOTO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/173,647

(22) Filed: Jul. 15, 2008

(30) Foreign Application Priority Data
Nov. 28, 2007 (JP) 2007-306730

(51) Int. Cl. G06K 9/50

(52) U.S. Cl. 382/180

(57) ABSTRACT

An image processing apparatus includes a segment length measuring unit, a segment specifying unit and an information embedding unit. The segment length measuring unit measures lengths of line segments in a pixel block contained in an image by scanning the pixel block. The segment specifying unit specifies a line segment in which information is to be embedded, based on a measurement result of the segment length measuring unit. The information embedding unit embeds the information by changing the length of the line segment specified by the segment specifying unit based on the information to be embedded.

### CROSS-REFERENCE TO RELATED APPLICATIONS

This application is based on and claims priority under 35 USC 119 from Japanese Patent Application No. 2007-306730 filed Nov. 28, 2007.

### BACKGROUND

1. Technical Field

The invention relates to an image processing apparatus, an image processing method, a compute-readable medium and a computer data signal.

2. Description of the Related Art

In the field of an information embedding technology for embedding information in a binary image, there has been proposed a technique of embedding information by dividing an image into plural blocks and inverting pixels in the blocks to adjust the number of black pixels. The expression “embedding information in an image” means modifying the image in accordance with the information, and also means reading the modified image with a scanner and to performing image processing for the read image so as to take out the embedded information from the read image.

### SUMMARY

According to an aspect of the invention, an image processing apparatus includes a segment length measuring unit, a segment specifying unit and an information embedding unit. The segment length measuring unit measures lengths of line segments in a pixel block contained in an image by scanning the pixel block. The segment specifying unit specifies a line segment in which information is to be embedded, based on a measurement result of the segment length measuring unit. The information embedding unit embeds the information by changing the length of the line segment specified by the segment specifying unit based on the information to be embedded.

### BRIEF DESCRIPTION OF THE DRAWINGS

Exemplary embodiments of the invention will be described in detail based on the following figures, wherein:

FIG. 1 is a module configuration diagram conceptually showing a configuration example of an exemplary embodiment (information embedding apparatus) of the invention;

FIG. 2 is a flowchart illustrating an example of processes performed by the information embedding apparatus;

FIG. 3 is a diagram illustrating an example of a process of extracting a circumscribed rectangle;

FIG. 4 is an explanatory diagram showing an example of a process of measuring a length of a run length;

FIG. 5 is an explanatory diagram showing an example of a process of embedding information;

FIG. 6 is a module configuration diagram conceptually showing a configuration example of another exemplary embodiment (information decoding apparatus) of the invention;

FIG. 7 is a flowchart illustrating an example of processes performed by the information decoding apparatus; and

FIG. 8 is a block diagram illustrating the hardware configuration of a computer for embodying the exemplary embodiments.

### DETAILED DESCRIPTION

Hereinafter, exemplary embodiments of the invention will be described with reference to the accompanying drawings.

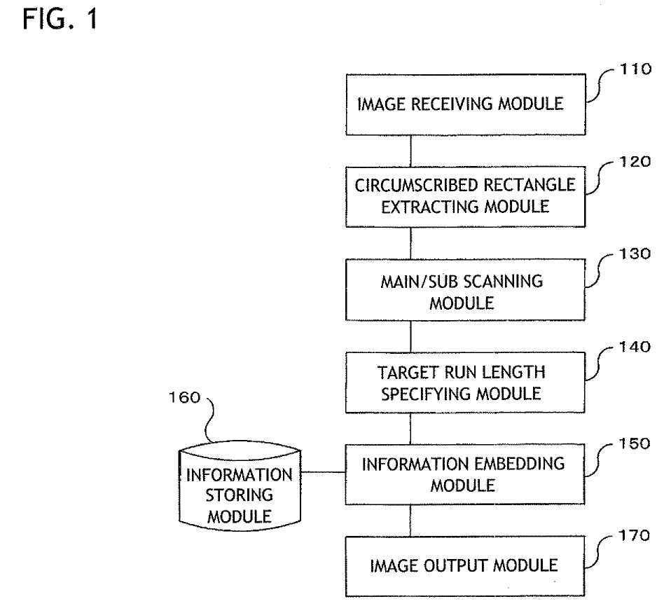

FIG. 1 is a module configuration diagram conceptually showing a configuration example of an exemplary embodiment (information embedding apparatus) of the invention.

Here, the term “module” means a component, such as software (computer program) components or hardware, which is logically dividable. Accordingly, the modules in this exemplary embodiment include modules having a hardware configuration, as well as modules in the computer program. Therefore, this exemplary embodiment also serves as description on a computer program, a system, and a method. Here, “store”, “cause something to store”, and words equivalent thereto are used for the purpose of convenient explanation. When this exemplary embodiment is a computer program, these words mean that information is stored in a memory or that a memory is controlled to store information therein. A module corresponds to a function almost in one to one correspondence. However, actually, one module may be embodied by one program, plural modules may be embodied by one program, or one module may be embodied by plural programs. Plural modules may be executed by one computer, or one module may be executed by plural computers in a distributed or parallel environment. One module may include another module. Also, in the following description, the term “connection” includes logical connection (transmission and reception of data, instruction, a reference relation among data), as well as physical connection.

Also, a system or a device may be embodied by plural computers, hardware structures, or devices connected to each other through a communication device such as a network (including one-to-one communicating connection), or may be embodied by a single computer, a single hardware structure, or a single device. The terms “device” and “system” are used as synonyms.

An image to be processed may include plural images, may be a binary image or a multilevel image (including a color image). Hereinafter, a binary image is mainly exemplified as the image to be processed.

The longitudinal side and the transverse side of a circumscribed rectangle mean two sides of the circumscribed rectangle which intersect each other at right angle. In this exemplary embodiment, a main scanning direction may be referred to as a transverse direction, and a sub-scanning direction may be referred to as a longitudinal direction.

An image embedding apparatus includes an image receiving module 110, a circumscribed rectangle extracting module 120, a main/sub scanning module 130, a target run length specifying module 140, an information embedding module 150, an information storing module 160 and an image output module 170.

The image receiving module 110 is connected to the circumscribed rectangle extracting module 120. The image receiving module 110 receives an image in which information is to be embedded and sends the received image to the circumscribed rectangle extracting module 120. Specifically, the image receiving module 110 receives an image by using a scanner, receives an image from an external device through a communication line such as a facsimile, or receives an image from a memory medium.

The circumscribed rectangle extracting module 120 is connected to the image receiving module 110 and the main/sub scanning module 130. The circumscribed rectangle extracting module 120 receives the image from the image receiving module 110 and extracts a circumscribed rectangle of a pixel block in the image. Then, the circumscribed rectangle extracting module 120 sends to the main/sub scanning module 130 information (position information of the left-upper corner of the circumscribed rectangle, the longitudinal length of the circumscribed rectangle, the transverse length of the circumscribed rectangle, and the like) of the extracted circumscribed rectangle.

The main/sub scanning module 130 is connected to the circumscribed rectangle extracting module 120 and the target run length specifying module 140. The main/sub scanning module 130 receives the information of the circumscribed rectangle from the circumscribed rectangle extracting module 120, measures lengths of line segments in the pixel block by scanning the circumscribed rectangle, and sends the measurement result to the target run length specifying module 140. The scanning operation may include both a main scanning operation and a sub scanning operation. In this exemplary embodiment, the main scanning operation is mainly exemplified.

The target run length specifying module 140 is connected to the main/sub scanning module 130 and the information embedding module 150. The target run length specifying module 140 receives the measurement result from the main/sub scanning module 130. The target run length specifying module 140 specifies a run length in which information is to be embedded, based on the measurement result. Then, the target run length specifying module 140 sends the specified run length to the information embedding module 150. The specified run length is the longest run length in the circumscribed rectangle.

The information embedding module 150 is connected to the target run length specifying module 140, the information storing module 160, and the image output module 170. The information embedding module 150 receives the specified run length from the target run length specifying module 140. Then, the information embedding module 150 calculates a reference length based on the transverse length or the longitudinal length of the circumscribed rectangle extracted by the circumscribed rectangle extracting module 120. Then, the information embedding module 150 reads the information to be embedded from the information storing module 160, changes a length of the received run length, and sends the changed image to the image output module 170. For example, the reference length is set to be a length (specifically, 1/10 of the transverse length of the circumscribed rectangle) smaller than the transverse length of the circumscribed rectangle. If the information to be embedded is “0”, the information embedding module 150 changes a length of the run length so as to be greater than the specified run length and to be equal to even multiple of the reference length (that is, lengthening the run length by adding black pixels). If the information to be embedded is “1”, the information embedding module 150 changes the length of the specified run length so as to be greater than the length of the specified run length and to be equal to odd multiple of the reference length.

The information storing module 160 stores the information to be embedded and sends the information to be embedded in response to an access from the information embedding module 150.

The image output module 170 is connected to the information embedding module 150. The image output module 170 receives the image in which the information is embedded by the information embedding module 150 and outputs the image. The expression “output the image” includes printing the image by a printer, displaying the image by a display, transmitting the image by a facsimile device, and writing the image into an image database.

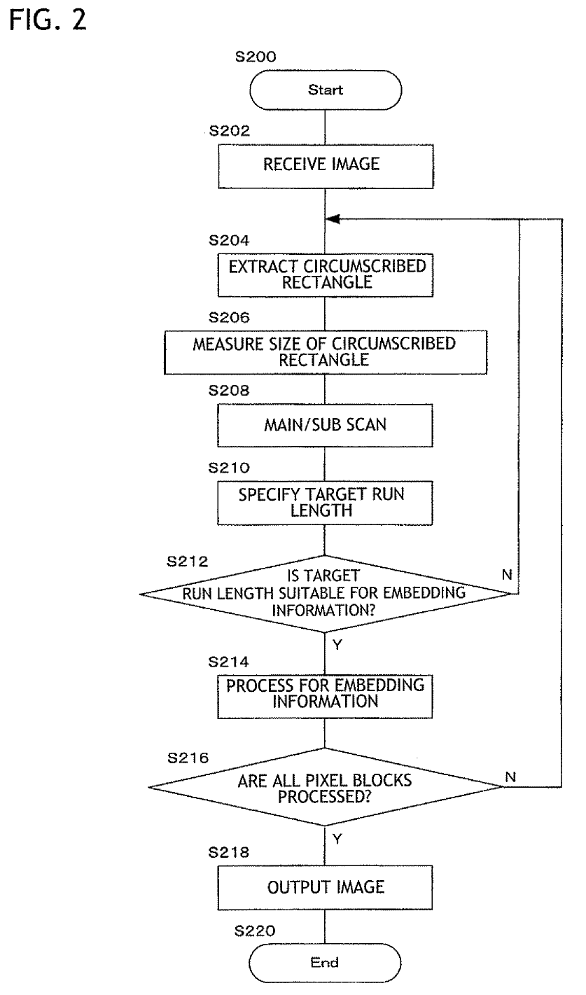

Operations and functions will be described with reference to FIGS. 2 to 5.

A process example of an image embedding apparatus will be described with reference to a flowchart shown in FIG. 2. The case where information is embedded in a pixel block of “A” in an image will be described as a specific example.

In step S202, the image receiving module 110 receives an image in which information is to be embedded.

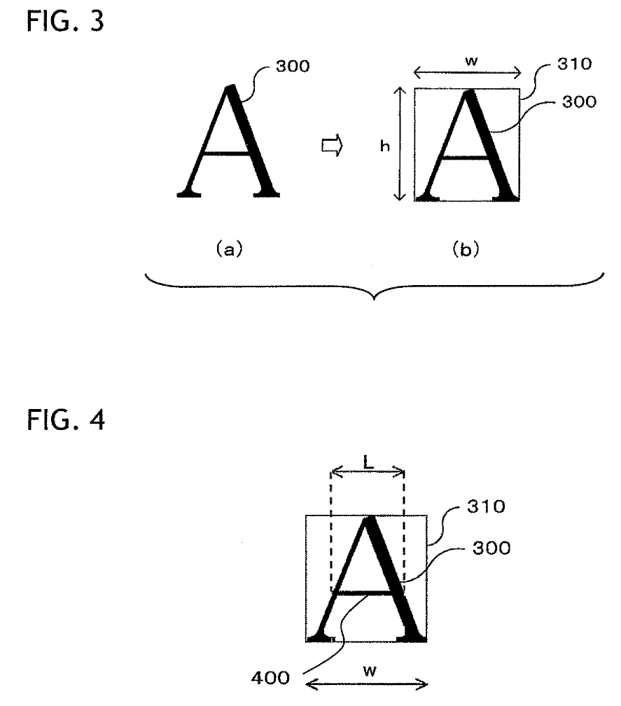

In step S204, the circumscribed rectangle extracting module 120 extracts a circumscribed rectangle of a pixel block in the image received in step S202. As shown in FIG. 3(a), the circumscribed rectangle extracting module 120 sets a character “A” 300 as a target pixel block (a pixel block to be processed), and as shown in FIG. 3(b), the circumscribed rectangle extracting module 120 extracts a circumscribed rectangle 310 of the character “A” 300.

In step S206, the circumscribed rectangle extracting module 120 measures position information (x,y) of the left-upper corner of the circumscribed rectangle 310 extracted in step S204 and the longitudinal length (h) and the transverse length (w) of the circumscribed rectangle 310 extracted in step S204.

In step S208, the main/sub scanning module 130 measures lengths of line segments in the pixel block by main-scanning an image in the circumscribed rectangle extracted in step S204. That is, the main/sub scanning module 130 measures run lengths in the transverse direction of the character “A” 300.

In step S210, the target run length specifying module 140 compares the run lengths measured in step S208 with each other and extracts the longest run length. As shown in an example of FIG. 4, the longest run length is set as a run length in question 400 in which information is to be embedded. L denotes the length of the longest run length. When the plural longest run lengths exist, the run length being located in a predetermined position (at the lowermost, at the rightmost, or the like) is selected.

In step S212, the target run length specifying module 140 determines as to whether or not the target run length is suitable for embedding of information. If the target run length is suitable, the flow proceeds to step S214. Otherwise, the flow returns to step S204. In determining as to whether or not the target run length is suitable for embedding of information, if the longest run length is equal to the transverse length of the circumscribed rectangle, the target run length specifying module 140 determines that the target run length is not suitable. This is because when information is embedded, the reference length is changed. Specifically, for example, information should not be embedded in characters such as “−” and “+”.

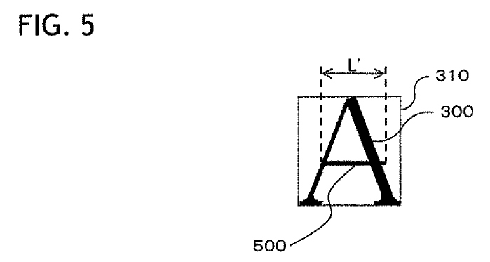

In step S214, the information embedding module 150 calculates the reference length based on the longitudinal length or the transverse length of the circumscribed rectangle and performs a process for embedding information in the longest run length. For example, it is assumed that the reference length S is equal to 1/10 of the transverse length of the circumscribed rectangle and the longest run length is L. Then, when information “0” is embedded, a changed run length L′ is set to be equal to a least even multiple of S which is equal to or greater than L. That is, L′=2n×S (where n is an integer of 1 or more). When information “1” is embedded, the changed run length L′ is set to be equal to a least odd multiple of S which is equal to or greater than L. That is, L′=(2n+1)×S (where n is an integer of 0 or more). Accordingly, as shown in FIG. 5, the target run length 400 is lengthened as the processed run length 500.

In step S216, it is determined as to whether the above-mentioned processes are performed for all the pixel blocks in the image. If the processes are performed for all the pixel blocks, the flow proceeds to step S218. Otherwise, the flow returns to step S204.

Step S218, the image output module 170 outputs the image having information embedded therein.

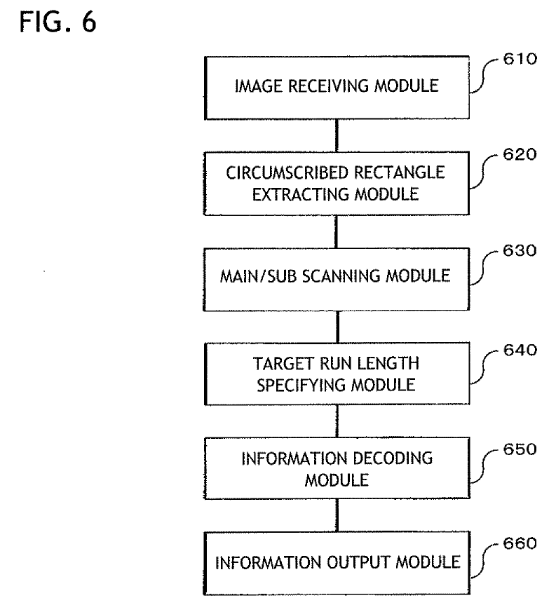

FIG. 6 is a module configuration diagram conceptually showing a configuration example of another exemplary embodiment (information decoding apparatus) of the invention. The information decoding apparatus analyzes an image in which information is embedded by the information embedding apparatus, and extracts the embedded information.

The information decoding apparatus includes an image receiving module 610, a circumscribed rectangle extracting module 620, a main/sub scanning module 630, a target run length specifying module 640, an information decoding module 650, and an information output module 660.

The image receiving module 610 is connected to the circumscribed rectangle extracting module 620 and has the same function as the image receiving module 110 of the information embedding apparatus.

The circumscribed rectangle extracting module 620 is connected to the image receiving module 610 and the main/sub scanning module 630 and has the same function as the circumscribed rectangle extracting module 120 of the information embedding apparatus.

The main/sub scanning module 630 is connected to the circumscribed rectangle extracting module 620 and the target run length specifying module 640 and has the same function as the main/sub scanning module 130 of the information embedding apparatus.

The target run length specifying module 640 is connected to the main/sub scanning module 630 and the information decoding module 650 and has the same function of the target run length specifying module 140 of the information embedding apparatus.

The information decoding module 650 is connected to the target run length specifying module 640 and the information output module 660. The information decoding module 650 receives the specified run length from the target run length specifying module 640. Then, the information decoding module 650 calculates a reference length based on the transverse length or the longitudinal length of the circumscribed rectangle extracted by the circumscribed rectangle extracting module 620. The information decoding module 650 decodes the embedded information based on the reference length and the specified run length and sends the decoded information to the information output module 660. Specifically, for example, when the reference length is set to a length smaller than the transverse length of the circumscribed rectangle (more specifically, is set to 1/10 of the transverse length of the circumscribed rectangle) and when the specified run length is an even multiple of the reference length, the information decoding module 650 obtains decodes the embedded information and obtains “0.” When the specified run length is an odd multiple of the reference length, the information decoding module 650 decodes the embedded information and obtains “1.”

The information output module 660 is connected to the information decoding module 650. The information output module 660 receives the information decoded by the information decoding module 650 and outputs the received information. The output of information includes sending the information to an output unit such as a display of the information decoding apparatus and transmitting the information to another information processing device.

Operations and Functions Will Be Described.

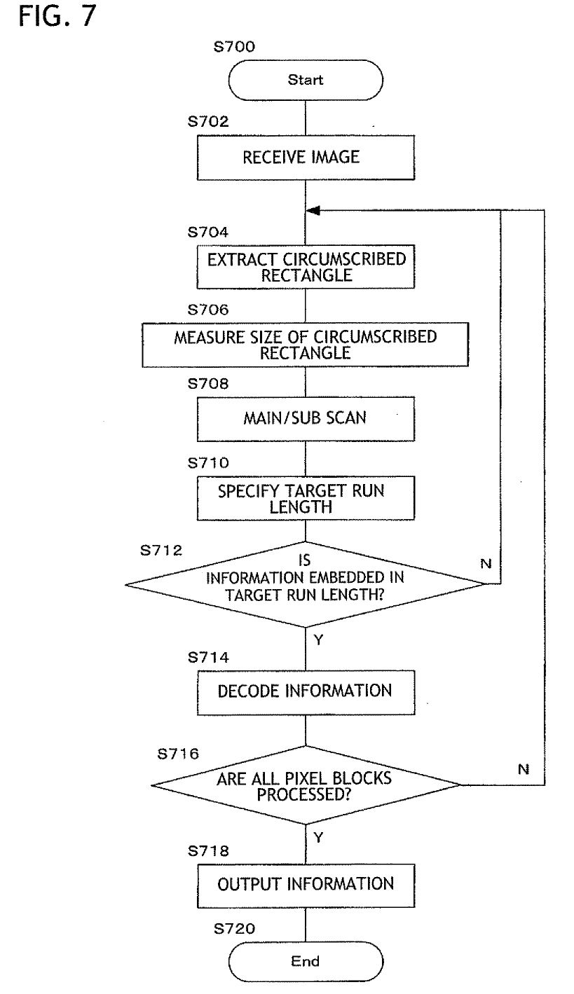

An operation of the information decoding apparatus is described with reference to a flowchart shown in FIG. 7.

Processes of steps S700 to S710 are the same as the processes of steps S200 to S210 in the flowchart shown in FIG. 2.

In step S712, the target run length specifying module 640 determines as to whether or not information is embedded in the target run length. If information is embedded, the flow proceeds to step S714. Otherwise, the flow returns to step S704. In determining as to whether or not information is embedded, if the longest run length is equal to the transverse length of the circumscribed rectangle, the target run length specifying module 640 determines that no information is embedded. Specifically, for example, information is not be embedded in characters such as “−” and “+.”

In step S714, the information embedding module 650 calculates the reference length based on the longitudinal length or the transverse length of the circumscribed rectangle and decodes the embedded information based on the longest run length. Specifically, for example, it is assumed that the reference length S is equal to 1/10 of the transverse length of the circumscribed rectangle and that the longest run length is L. Then, if L is an even multiple of S, information “0” is embedded. Also if L is an odd multiple of S, information “1” is embedded.

In step S716, the information embedding module 650 determines as to whether or not the above-mentioned processes are performed for all the pixel blocks in the image. If the processes are performed for all the pixel blocks, the flow proceeds to step S718. Otherwise, the flow returns to step S704.

Step S718, the image output module 660 outputs the image having information embedded therein.

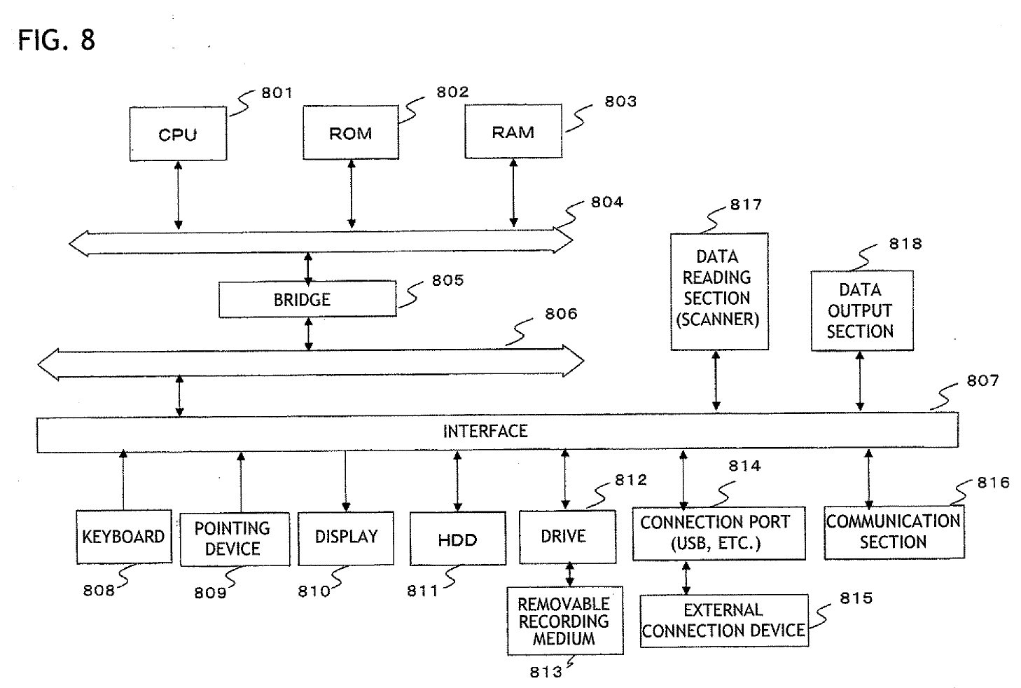

The hardware configuration of this exemplary embodiment will be described with reference to FIG. 8. The configuration shown in FIG. 8 is embodied, for example, by a personal computer (PC) or the like. Here, the hardware configuration includes a data reading section 817 such as a scanner and a data output section 818 such as a printer.

A CPU (Central Processing Unit) 801 serves as a controller performing processes based on computer programs having execution sequences of various modules described in the above-mentioned embodiment, such as the image receiving module 110, the circumscribed rectangle extracting module 120, the main/sub scanning module 130, the target run length specifying module 140, and the information embedding module 150 described therein.

A ROM (Read Only Memory) 802 stores programs or calculation parameters used in the CPU 801. A RAM (Random Access Memory) 803 stores programs used for execution of the CPU 801 or parameters properly varying in the execution. These are connected to each other through a host computer 804 including a CPU bus.

The host bus 804 is connected to an external bus 806 such as a PCI (Peripheral Component Interconnect/Interface) bus through a bridge 805.

A keyboard 808 and a pointing device 809 such as a mouse are input devices operated by an operator. A display 810 is embodied by a liquid crystal display or a CRT (Cathode Ray Tube) and serves to display various information as texts or image information.

An MDD (Hard Disk Drive) 811 has a hard disk built therein and drives the hard disk to record or reproduce programs or information executed by the CPU 801 The hard disk serves as the information storing module 160 and stores information and the like to be embedded. The hard disk also stores various computer programs such as data processing programs.

A drive 812 reads data or programs recorded in a removable recording medium 813 such as a magnetic disk, an optical disk, a magneto-optic disk, and a semiconductor memory and supplies the data or programs to the RAM 803 connected thereto through the interface 807, the external bus 806, the bridge 805, and the host bus 804. The removable recording medium 813 can be also used as the same data recording area as the hard disk.

A connection port 814 is a port for connection to an external connection device 815 and includes a connection portion such as USB and IEEE 1394. The connection port 814 is connected to the CPU 801 through the interface 807, the external bus 806, the bridge 805, and the host bus 804. A communication section 816 is connected to a network and performs a data communication process with the outside. The data reading section 817 is embodied, for example, by a scanner and performs a process of reading a document. The data output section 818 is embodied, for example, by a printer and performs a process of outputting document data.

The hardware configuration shown in FIG. 8 is only an example. This exemplary embodiment is not limited to the configuration shown in FIG. 8, and may have any configuration so long as it can execute the above-mentioned modules. For example, some modules may be embodied by exclusive hardware (such as an application specific integrated circuit (ASIC)), some modules may be disposed in an external system and may be connected through a communication line, or the plural systems shown in FIG. 8 may be connected to each other through a communication line so as to operate in cooperation with each other. Some modules may be mounted on a copier, a facsimile, a scanner, a printer, or a multi-function device (an image processing apparatus having two or more functions of a scanner, a printer, a copier, and a facsimile).

The information embedding apparatus and the information decoding apparatus may be combined to form an integrated information embedding/decoding apparatus. That is, the information embedding/decoding apparatus has all the modules shown in FIGS. 1 and 6. Alternatively, the image receiving module 110, the circumscribed rectangle extracting module 120, the main/sub scanning module 130, and the target run length specifying module 140 may be also used as the image receiving module 610, the circumscribed rectangle extracting module 620, the main/sub scanning module 630, and the target run length specifying module 640, respectively. A user may be made to instruct the embedding or decoding of information, and information may be embedded in an image or may be decoded from the image in accordance with the user's instruction. In addition to the instruction from the user, it may be determined as to whether or not information is embedded based on an instruction from another device. For example, when all the longest run lengths are an odd multiple or an even multiple of the reference length, it may be determined that information is embedded. If it is determined that information is embedded, the information is decoded. If it is determined that no information is embedded, information is embedded.

The number of run lengths in which information is to be embedded is 1 in the above-mentioned exemplary embodiment. Alternatively, plural run lengths adjacent to each other may be treated as one run length. The plural run lengths adjacent to each other may be only run lengths having the same length or may be run lengths having a length of which a difference from the longest run length is in a range of a predetermined length.

The run length in which information it to be embedded is the longest run length in one circumscribed rectangle in the above-mentioned exemplary embodiment. Alternatively, the run length in which information it to be embedded may be the longest run length in plural continuous circumscribed rectangles. That is, the longest run length in the plural continuous circumscribed rectangles may be specified and information may be embedded in the longest run length.

In the above-mentioned exemplary embodiment, the reference length is determined based on the transverse length of the circumscribed rectangle, and the longest run length is one extending in the main scanning direction. Alternatively, the reference length may be determined based on the longitudinal length of the circumscribed rectangle, and the longest run length may be one extending in the sub-scanning direction. Alternatively, the reference length may be determined based on the transverse length of the circumscribed rectangle, and the longest run length may be one elongating in the sub-scanning direction, or vice versa. The reference length may be determined based on the longer one (or the shorter one) of the longitudinal length and the transverse length of the circumscribed rectangle. The longest run length may be the longest one among run lengths in the main scanning direction and run lengths in the sub-scanning direction.

In the above-mentioned exemplary embodiment, the longest run length is an even multiple of the reference length when information “0” is embedded, and the longest run length is an odd multiple of the reference length when information “1” is embedded. However, the opposite condition may be used.

The above-mentioned program may be stored in a recording medium or the program may be provided through communication means. In this case, for example, the above-mentioned program may be embodied as an invention of “computer-readable recording medium having a program recorded thereon”.

The “computer-readable recording medium having a program recorded thereon” means a recording medium on which a program is recorded, which is readable by a computer, and which is used for installation, execution, and circulation of programs.

Examples of the recording medium include a digital versatile disk (DVD) such as “DVD−R, DVD−RW, and DVD)-RAM” of which the standard is defined in a forum for DVD and “DVD+R and DVD+RW” of which the standard is defined as DVD+RW, a compact disk (CD) such as a read only memory (CD-ROM), a CD recordable (CD-R), and a CD rewritable (CD-RW), a magneto-optic disk (MO), a flexible disk (FD), a magnetic tape, a hard disk, a read only memory (ROM), an electrically erasable and programmable read only memory (EEPROM), a flash memory, and a random access memory (RAM).

The above-mentioned program or a part thereof may be recorded in the recording medium and then may be conserved or circulated in that state. The program or a part thereof may be transmitted by communication using a transmission medium such as a wired communication network, a wireless communication network, or a combination thereof, which is used, for example, in a local area network (LAN), a metropolitan area network (MAN), a wide area network (WAN), the Internet, the Intranet, the Extranet, and the like, or may be transmitted with carrier waves.

The program may be a part of another program, or may be recorded in a recording medium along with another program. The program may be distributed and recorded in plural recording mediums. The program may be recorded in any method such as compression or encryption, as long as it can be reproduced.

What is claimed is:

1. An image processing apparatus comprising:
a segment length measuring unit that measures lengths of line segments in a pixel block contained in an image by scanning the pixel block;
a segment specifying unit that specifies a line segment in which information is to be embedded, based on a measurement result of the segment length measuring unit; and
an information embedding unit that embeds the information by changing the length of the line segment specified by the segment specifying unit based on the information to be embedded.

2. An image processing apparatus comprising:
a segment length measuring unit that measures lengths of line segments in a pixel block contained in an image by scanning the pixel block;
a segment specifying unit that specifies a line segment in which information is embedded, based on a measurement result of the segment length measuring unit; and
an information decoding unit that decodes the embedded information based on the measurement result of the segment length measuring unit.

3. The image processing apparatus according to claim 1, wherein
the segment specifying unit further specifies a line segment in which information is embedded, based on the measurement result of the segment length measuring unit, the image processing apparatus further comprising:
an information decoding unit that decodes the embedded information based on the measurement result of the segment length measuring unit.

4. The image processing apparatus according to claim 1, further comprising:
an extracting unit that extracts a rectangle area surrounding the block pixel, wherein
the information embedding unit calculates a reference length based on a longitudinal length or a transverse length of the rectangle area extracted by the extracting unit, and
the information embedding unit changes, based on the reference length and the information to be embedded, a length of the line segment specified by the segment specifying unit to an even multiple or an odd multiple of the reference length.

5. The image processing apparatus according to claim 2, further comprising:
an extracting unit that extracts a rectangle area surrounding the block pixel, wherein
the information embedding unit calculates a reference length based on a longitudinal length or a transverse length of the rectangle area extracted by the extracting unit, and
the information embedding unit decodes the embedded information based on whether the measurement result of the segment length measuring unit indicates an even multiple or an odd multiple of the reference length.

6. A computer-readable medium storing a program that causes a computer to execute image processing, the image processing comprising:
extracting a circumscribed rectangle of a pixel block in an image;
measuring lengths of line segments in the pixel block by scanning the extracted circumscribed rectangle;
specifying a line segment in which information is to be embedded, based on a result of the measuring; and
embedding the information by changing the length of the specified line segment based on a longitudinal length or a transverse length of the extracted circumscribed rectangle and the information to be embedded.

7. A computer-readable medium storing a program that causes a computer to execute image processing, the image processing comprising:
extracting a circumscribed rectangle of a pixel block in an image;
measuring lengths of line segments in the pixel block by scanning the extracted circumscribed rectangle;
specifying a line segment in which information is embedded, based on a result of the measuring; and
decoding the embedded information based on a longitudinal length or a transverse length of the extracted circumscribed rectangle and the result of the measuring.

8. The computer-readable medium according to claim 6, wherein the image processing further comprises:
specifying a line segment in which information is embedded, based on the result of the measuring; and
decoding the embedded information based on the longitudinal length or the transverse length of the extracted circumscribed rectangle and the result of the measuring.

9. An image processing method comprising:
extracting a circumscribed rectangle of a pixel block in an image;
measuring lengths of line segments in the pixel block by scanning the extracted circumscribed rectangle;
specifying a line segment in which information is to be embedded, based on a result of the measuring; and
embedding the information by changing the length of the specified line segment based on a longitudinal length or a transverse length of the extracted circumscribed rectangle and the information to be embedded.

10. An image processing method comprising:
extracting a circumscribed rectangle of a pixel block in an image;
measuring lengths of line segments in the pixel block by scanning the extracted circumscribed rectangle;
specifying a line segment in which information is embedded, based on a result of the measuring; and
decoding the embedded information based on a longitudinal length or a transverse length of the extracted circumscribed rectangle and the result of the measuring.

11. The image processing method according to claim 9, further comprising:
specifying a line segment in which information is embedded, based on the result of the measuring; and
decoding the embedded information based on the longitudinal length or the transverse length of the extracted circumscribed rectangle and the result of the measuring.
